(19) United States
(12) Patent Application Publication
(10) Pub. No.: US 2006/0218629 A1
(43) Pub. Date: Sep. 28, 2006

(54) System and method of tracking single sign-on sessions

(75) Inventors: Larry B. Pearson, San Antonio, TX (US); James M. Doherty, Georgetown, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, LP

(21) Appl. No.: 11/086,770

(22) Filed: Mar. 22, 2005

(51) Int. Cl. G06F 17/30

(52) U.S. Cl. 726/8

(57) ABSTRACT

A service delivery system is disclosed and includes a first service provider platform and a second service provider platform. Further, the service delivery system includes an identity provider system that provides a single sign-on service with respect to the first service provider platform and the second service provider platform. The service delivery system also includes a log server to store session information created at the first service provider platform, the second service provider platform, and the identity provider system. Additionally, the service delivery system includes a customer care application server that provides a customer care application. The customer care application server has access to the log server in order to retrieve the stored session information.

### FIELD OF THE DISCLOSURE

The present disclosure relates to Internet services and to tracking single sign-on sessions.

### BACKGROUND

Federated identity management can be used by an Internet service provider to provide single sign-on between different portals and services. Single sign-on provides end users with the ability to log into a parent service and move freely between affiliated services without having to login again after the first login. Once logged in to a parent service, the end user can logoff once and automatically be logged out of all of the affiliated services. The end user's web browser session remains active as long as the end user interacts with one of the affiliated services.

Each affiliated service offered in conjunction with a parent service, may, or may not be, provided by a different service provider. Further, with the current method of single sign-on, it may be difficult to track a user's movement during browsing because the user does not have to separately log into each service associated with the parent service. Additionally, each service can be served by a separate operations and support team. When a customer has a problem while browsing, he or she may have to contact multiple customer care centers in order to determine the source of the problem. Having to contact multiple customer care centers can be extremely frustrating to the customer and may cause the customer to find a new service provider.

Accordingly, there is a need an improved system and method of tracking customer single sign-on sessions.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of a computer system;

FIG. 2 is a block diagram representative of an alternative computer system;

FIG. 3 is a ladder diagram to illustrate a method of end-user session logging;

FIG. 4 is a ladder diagram to illustrate an alternative method of end-user session logging;

FIG. 5 is a ladder diagram to illustrate a method of end-user session termination;

FIG. 6 is a block diagram representative of another alternative computer system; and

FIG. 7 is a ladder diagram to illustrate another alternative method of end-user session termination.

### DETAILED DESCRIPTION OF THE DRAWINGS

A service delivery system is disclosed and includes a first service provider platform and a second service provider platform. Further, the service delivery system includes an identity provider system that provides a single sign-on service with respect to the first service provider platform and the second service provider platform. The service delivery system also includes a log server to store session information created at the first service provider platform, the second service provider platform, and the identity provider system. Additionally, the service delivery system includes a customer care application server that provides a customer care application. The customer care application server has access to the log server in order to retrieve the stored session information.

In a particular embodiment, the single sign-on service is compliant with a federated identity environment. Alternatively, the single sign-on service is compliant with a web trust identity environment. In another particular embodiment, the service delivery system further includes a plurality of log servers and a master log server that is responsive to the identity provider system. The master log server includes logic to identify, in response to a request from the customer care application server, one of the plurality of log servers that has session information with respect to an end-user session identified by a single sign-on username.

In yet another particular embodiment, the stored session information is consolidated customer session information. Further, in a particular embodiment, the federated identity environment is a Liberty Alliance standard compliant environment. Also, in still another particular embodiment, the customer care application server provides data to a customer server browser for use by a customer care service representative.

In another particular embodiment, the customer care service representative handles a call from a subscriber to a service offered in connection with the first service provider platform, the second service provider platform, or a combination thereof. Additionally, in a particular embodiment, the first service provider platform is an interactive web portal platform and the second service provider platform supports a communications services offering.

In another embodiment, a system is disclosed and includes a plurality of log servers that store session information that is created at a plurality of service provider platforms and a plurality of identity provider systems. The system also includes a master log server that is responsive to at least one of the plurality of identity provider systems. The master log server includes logic to identify, in response to a customer care request, one of the plurality of log servers having session information corresponding to a particular end-user session identified by a single sign-on username. In this embodiment, the system further includes a customer care application server that provides a customer care application to support a customer care representative, the customer care application server that is coupled to the master log server in order to provide the customer care request and having access to each of the plurality of log servers to retrieve consolidated multi-service session information related to the particular end-user session identified by the single sign-on username.

In yet another embodiment, a method of creating a single sign-on session is disclosed and includes receiving a login request from a browser, determining whether the browser has an active session, and transmitting a login form to the browser. Additionally, the method includes receiving a completed login form including a user identity information from the browser and authenticating the user identity information. In this embodiment, the method also includes identifying a log server to use for logging information related to a single sign-on session associated with the user identity information and determining an opaque session identifier associated with the single sign-on session.

In still another embodiment, a method of accessing a service provider when a prior single sign-on session is in place is disclosed and includes receiving a login request from a browser and determining that the browser has an active session. Further, the method includes identifying a log server to use for logging of information related to the active session and determining an opaque session identifier.

In yet still another embodiment, a method of single sign-off is disclosed and includes receiving a single sign-off request from a browser at a identity provider, determining whether the browser has a valid session, and submitting a first log record to a master log server. In this embodiment, the first log record includes a single sign-on username, an identity provider identifier, a log server identifier, an opaque session identifier, a timestamp, and a record type identifier that indicates a session termination.

In still yet another embodiment, a system is disclosed and includes a plurality of log servers that store session information created at a plurality of service provider platforms and at a plurality of reverse web proxy servers. The system also includes a master log server that is responsive to at least one of the plurality of reverse web proxy servers. The master log server includes logic to identify, in response to a customer care request, one of the plurality of log servers having session information corresponding to a particular end-user session identified by a single sign-on username. In this embodiment, the system also includes a customer care application server that provides a customer care application to support a customer care representative. The customer care application server is coupled to the master log server in order to provide the customer care request. Also, the customer care application server has access to each of the plurality of log servers in order to retrieve consolidated session information related to the particular end-user session identified by the single sign-on username.

In another embodiment, a method of creating a single sign-on session is disclosed and includes receiving a request from a browser at a reverse web proxy server and transmitting a login page to the browser. Further, the method includes receiving a completed login page from the browser. The completed login page includes user login information. The method also includes determining whether the login information is valid and determining a log server to use for session logging after determining that the login information is valid.

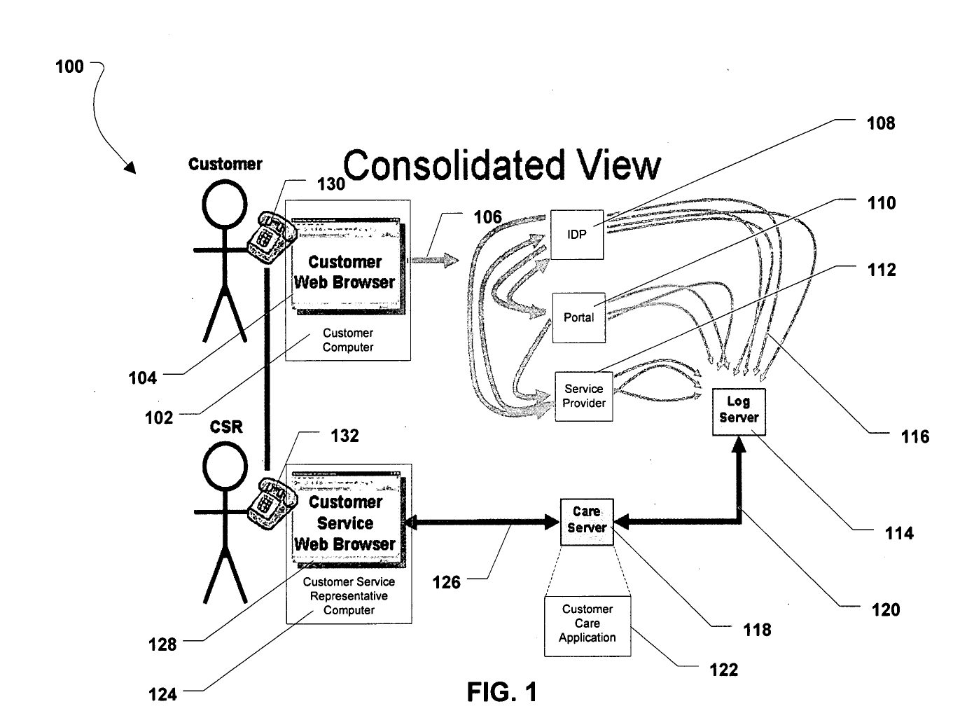

Referring to FIG. 1, a computer system is shown and is generally designated 100. As shown, the system 100 includes a customer computer 102 that includes a web browser 104 for communicating with various service providers via a network connection 106. In an illustrative embodiment, the customer computer 102 can communicate with an identity provider platform 108, a first service provider platform 110, such as an Internet portal, and a second service provider platform 112. In an alternative embodiment, the customer computer 102 can communicate with many more service provider platforms and identity provider platforms via the Internet connection 106. In a particular embodiment, the customer can conduct a session with one or more of the service providers 110, 112 using a single sign-on (SSO) login that is authenticated by the identity provider 108.

In a particular embodiment, the identity provider platform 108, the first service provider platform 110, and the second service provider platform 112 are coupled to each other and to a log server 114, e.g., by a plurality of network connections 116. Further, the log server 114 is coupled to a customer care application server 118 via a network connection 120. In a particular embodiment, the customer care application server 118 includes a customer care application 122. As further shown in FIG. 1, a customer service representative computer 124 is coupled to the customer care application server 118 via a network connection 126. In an illustrative embodiment, the customer service representative computer 124 includes a customer service web browser 128. FIG. 1 further illustrates a customer telephone 130 and a customer service representative telephone 132.

In a particular embodiment, while the customer communicates with the provider platforms 108, 110, 112, each of the provider platforms 108, 110, 112 can send logging information to the log server 114. Further, when a customer experiences a problem while communicating with one or more of the provider platforms 108, 110, 112, the customer can use the customer telephone 130 to call the customer service representative telephone 132 to speak with a customer service representative. The customer service representative can use the customer service web browser 126 to communicate with the customer care server 118, e.g., the customer care application 122 disposed therein. The customer care server 118, in turn, can retrieve consolidated customer session information from the log server 114 and transmit that consolidated customer session information to the customer service web browser 126 via the customer care server 118. The customer service representative can use the consolidated customer session information in order to trouble shoot the cause of problems experienced by the customer during one or more customer sessions.

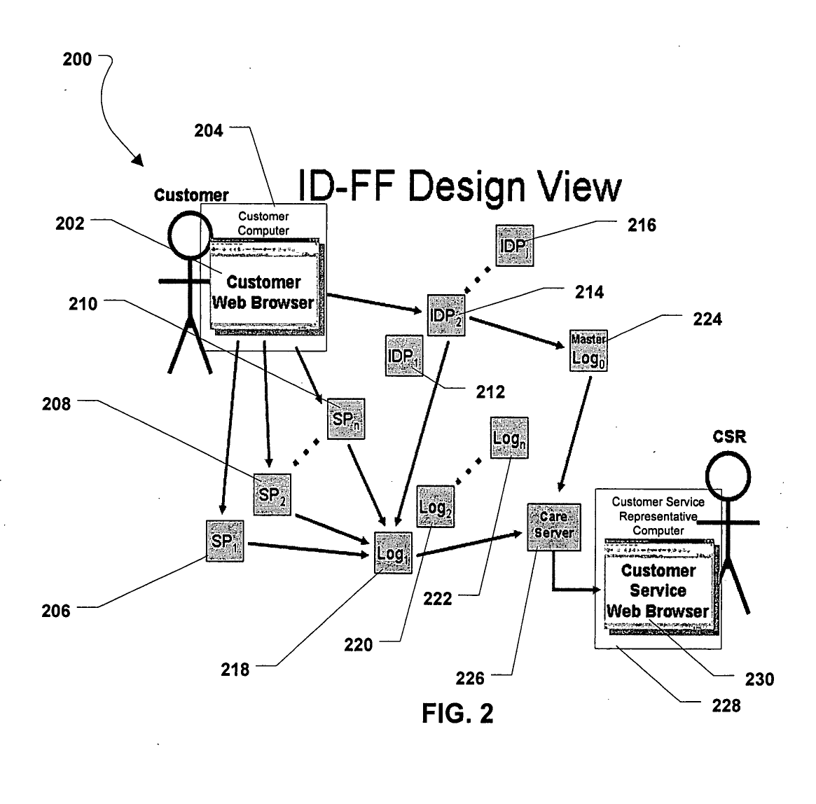

FIG. 2 shows a computer system, generally designated 200, suitable for use with the Liberty Alliance federated identity environment (ID-FF). As shown, the system 200 includes a customer computer 202 that includes a customer web browser 204. The customer computer 202 can communicate with a first service provider 206, a second service provider 208, and an nth service provider 210. Further, the customer computer 204 can communicate with a first identity provider 212, a second identity provider 214, and a jth identity provider 216. In an exemplary, non-limiting embodiment, each service provider 206, 208, 210 can communicate with a first log server 218, a second log server 220, and an nth log server 222. Further, each of the identity providers 212, 214, 216 can communicate with the log servers 218, 220, 222.

As illustrated in FIG. 2, each of the identity providers 218, 220, 222 communicates with a master log server 224. FIG. 2 further shows a customer care server 226 that communicates with the master log server 224 and an appropriate log server 218, 220, 222. A customer service representative computer 228 is coupled to the customer care server 226. The customer service representative computer 228 includes a customer service web browser 230 incorporated therein, e.g., stored within a computer readable medium.

In a particular embodiment, a customer can use the customer web browser 204 to access web sites via the Internet, e.g., the service providers 206, 208, 210 and the identity providers 212, 214, 216. Further, the log servers 218, 220, 222 communicate with the service providers 206, 208, 210; the identity providers 212, 214, 216; and the customer care server 226. In a particular embodiment, the master log server 224 indicates to the customer care server 226 where to find the authoritative log server 218, 220, 222 for each end-user session using the end-user's Single Sign-On (SSO) username (user ID) as an index. Once the customer care server 226 knows which log server 218, 220, 222 to pull information from, the customer care server 226 can pull the consolidated information from the appropriate log server 218, 220, 222 and present that information to a customer service representative via the customer service representative computer 228, e.g., the customer service web browser 230.

In a particular embodiment, the centralized system, described above, can collect session information from each of the service elements, e.g., the service providers 206, 208, 210 and the identity providers 212, 214, 216, and make consolidated session information available to a customer service representative. Accordingly, the customer service representative's visibility into how the customer is using their services is greatly enhanced.

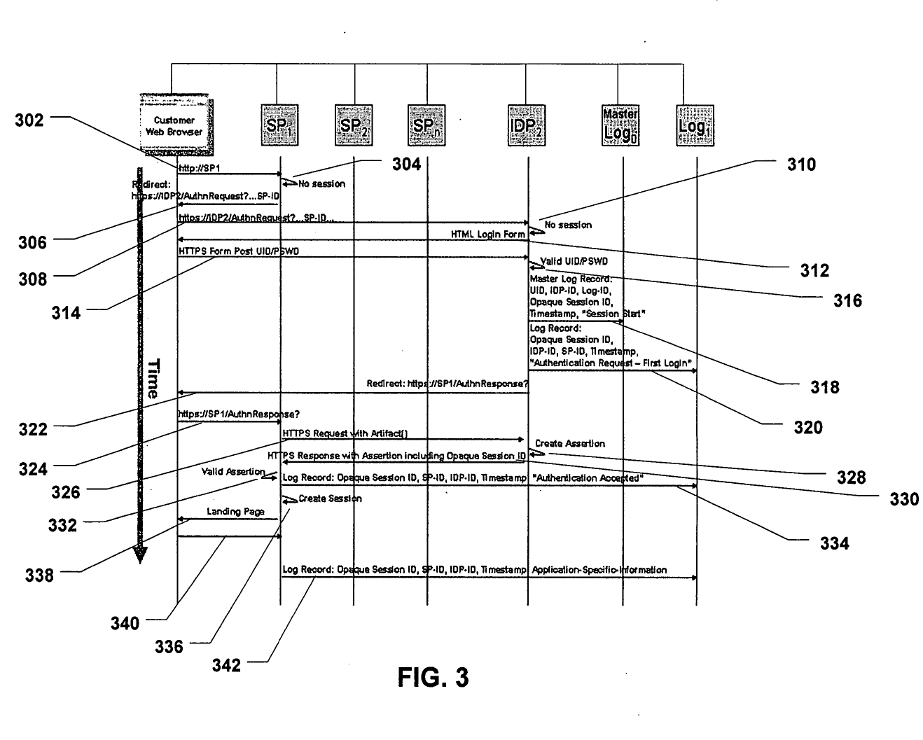

Referring to FIG. 3, a method of end-user session logging is presented as a ladder diagram. The method shown in FIG. 3 operates under the assumption that the customer does not have an active Single Sign-On session. Commencing at step 302, a customer points a customer web browser to a website provided by a service provider, e.g., a first service provider, such as an Internet portal site. At step 304, the first service provider website determines whether the customer has a valid web session. Since the customer has not logged in to a single sign-on session, the customer does not have a valid web session. In general, customer sessions are managed using cookies. However, for clarity in describing the present method, cookie exchanges are not shown in FIG. 3.

Moving to step 306, the first service provider website sends a hypertext transfer protocol (HTTP) redirect message to the web browser in order to indicate to the web browser to link to an identity provider, e.g., a second identity provider. In a particular embodiment, a redirect uniform resources location (URL) is sent to the web browser and includes additional information encoded therein including the type of request, e.g., Authentication Request or AuthnRequest, and the identification of the first service provider to be sent to the second identity provider.

At step 308, the customer web browser passes the login request from the first service provider to the second identity provider using information encoded in the URL. In a particular embodiment, that information includes the type of request (Authentication) and the identification of the first service provider on the second identity provider. The identification of the service provider can indicate to the second identity provider which service provider is requesting authentication services. Further, during step 308, the second identity provider attempts to retrieve a cookie from the customer web browser. If there is not a cookie or if the contents of the cookie reveal an invalid session identification, the second identity provider decides that the customer does not have a valid session. In a particular embodiment, a cookie is deposited (not shown) on the customer web browser. The cookie can be deposited in order to manage the session with the browser. However, this does not mean that there is a Single Sign-On session active.

Proceeding to step 310, the second identity provider determines whether the customer has an active session. Since there is not a valid Single Sign-On session, as described above, the second identity provider prompts the customer to login. At step 312, the second identity provider sends a hypertext markup language (HTML) login form to the customer web browser. Continuing to step 314, after the customer completes the login form, the customer browser posts the login form to the second identity provider. In a particular embodiment, the posted login form includes the customer user name, e.g., a user identification, and a password. At step 316, the second identity provider compares the user name and password provided by the customer with the values stored within a user database or directory within the second identity provider. When the values match, the customer is authenticated. Additionally, the second identity provider determines which log server to use for session logging. Further, the second identity provider determines an opaque session identifier.

In a particular embodiment, the second identity provider can determine which log server to assign to this particular customer session based on a variety of techniques. For example, this determination can be round robin, least utilized, random or otherwise load balancing in order to distribute end-user sessions across multiple log servers. The log server choice is be added to the session information maintained by the second identity provider web server. Also, in a particular embodiment, the opaque session identifier can be used to uniquely identify a particular customer's session from a pool of customer sessions for the time that the particular customer session is active on the second identity provider. In a particular embodiment, the second identity provider also adds the opaque session identifier to the per session information already maintained in the second identity provider web server. In a particular embodiment, the second identity provider internal session identifier should not be used for the opaque session identifier. Otherwise, anyone with access to the log systems could hijack in process customer web sessions.

Moving to step 318, the second identity provider sends a log record to the master log server that contains the customer's Single Sign-On username, the second identity provider identifier, the log server identifier, the opaque session identifier, a timestamp, and a record identifier that identifies that this is a “SSO Session Start” record. In a particular embodiment, this information allows downstream systems, e.g., customer care support systems, to find the correct logging server for a customer's Single Sign-On (SSO) session. In addition to the master log record that the second identity provider submits to the master log server, at step 320, the second identity provider submits a log record to a log server, e.g., to the first log server. In a particular embodiment, the log record indicates an SSO session start. Further, the log record includes the opaque session identifier, the identity provider identifier, the service provider identifier that is making the authentication request, a timestamp, and a record identifier that indicates that this is an “Authentication Request—First Login.”

Continuing to step 322, the second identity provider sends an authentication response redirect message back to the customer web browser. In a particular embodiment, the authentication response includes an artifact. Further, in a particular embodiment, the artifact is a data item that provides the information that the service provider (SP1) needs in order to receive authentication information from the second identity provider. Also, in a particular embodiment, the artifact is encoded within the URL. Additionally, in a particular embodiment, the redirect message can redirect the browser to the first service provider. At step 324, the customer web browser passes the authentication response with the artifact to the first service provider. Thereafter, at step 326, the first service provider initiates a web services request to the second identity provider. In a particular embodiment, the web service request includes the artifact that the first service provider receives from the second identity provider through the customer web browser. At step 328, the second identity provider validates the artifact in the web services request that is received from the first service provider. The second identity provider creates an assertion to pass back to the first service provider in a response.

The Liberty ID-FF protocol provides a method to include additional information in the assertion. Since ID-FF uses security assertion markup language (SAML) to form assertions, the additional information can be included in the SAML assertion. From a Liberty ID-FF perspective, the additional information can be included in the Liberty authentication context (<lib:AuthnContext>) portion of the protocol. In SAML, this information would be placed in the SAML advice (<saml:Advice>) portion of the SAML message. In a particular embodiment, the additional information can be in the form of tag value pairs. For example, there can be a tag value pair for the log server identifier, and the opaque session identifier. Including this information in identity provider (IDP) to service provider (SP) responses allows service providers to know which log server and which opaque session identifier to associate with the customer's session on the service provider.

Proceeding to step 330, the second identity provider responds to the first service provider with an assertion response that includes the log server identifier and the opaque session identifier. In a particular embodiment, the assertion response indicates to the first service provider to either allow access by the customer or deny access to the customer. Next, at step 332, the first service provider receives the assertion response from the second identity provider and processes the assertion response. When the assertion response indicates to allow access, the assertion response will include the log server identifier and the opaque session identifier. The first service provider can take the log server identifier and the opaque session identifier and associate this information with the customer's web session. In a particular embodiment, there may be additional work that the first service provider needs to perform in order to fully create a customer session. In a particular embodiment, this work is performed later, as shown at step 336.

Moving to step 334, the first service provider sends a log message to the first log server that includes the opaque session identifier, the first service provider identifier, and the second identity provider identifier, a timestamp, and a record identifier that indicates “Authentication Accepted” by the second identity provider. At step 336, the first service provider creates the remaining data structures necessary to create a web session for the authenticated customer web session. Next, at step 338, the first service provider transmits an initial page to the customer web browser. In a particular embodiment, the initial page can be a “landing page.” The “landing page” indicates to the customer that he or she has access to resources at the first service provider. In a particular embodiment, subsequent web activity or page refreshes occur between the first service provider and the customer web browser. In a particular embodiment, that activity may involve repeating one or more of the previous steps.

At step 340, the customer can follow a link at the first service provider or complete a form that gets posted to the first service provider. This activity can be considered a relevant event and each time a relevant event occurs, relevant information logging can take place. At step 340, if a relevant event does not occur the method loops back to step 338. Otherwise, when a relevant event occurs, the method proceeds to step 342 and the first service provider sends a log message to the first log server. In a particular embodiment, the log record includes the opaque session identifier, the first service provider identifier, the second identity provider identifier, a timestamp, and a record identifier that indicates “Application Specific Information.” In a particular embodiment, the method returns to step 338 until the customer session with the first service provider ends.

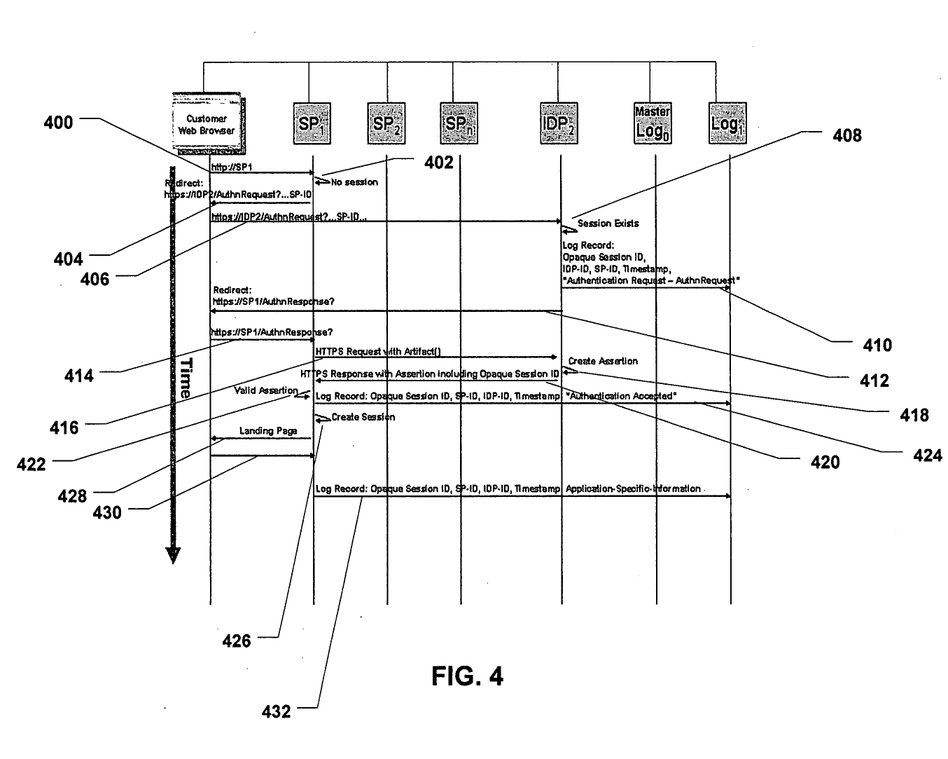

Referring to FIG. 4, an alternative method of end-user session logging is presented as a ladder diagram. In a particular embodiment, the method described below can be implemented when the customer already has a Single Sign-On (SSO) session active on an identity provider and accesses a service provider for the first time. In other words, the customer has a valid session on an identity provider, e.g., a second identity provider, but does not yet have a valid session on a service provider, e.g., a first service provider. Beginning at step 400, the customer points the customer web browser to a website provided by the first service provider. At step 402, the first service provider website determines whether the customer has a valid web session. Since the customer has not logged in, the customer does not have a valid web session. Typically, sessions are managed using cookies. However, cookie exchanges are not shown in FIG. 4.

Moving to step 404, the service provider website sends an HTTP redirect message to tell the customer web browser to link to the second identity provider. Additional information is encoded within the redirect URL. In a particular embodiment, the additional information includes the type of request, authentication request or AuthnRequest, and an identifier associated with the first service provider on the second identity provider. Proceeding to step 406, the customer web browser passes the login request from the first service provider to the second identity provider using information encoded in the URL. The encoded information can include the type of request (Authentication) and the first service provider identifier on the second identity provider. In a particular embodiment, the service provider identifier can indicate to the second identity provider which service provider is requesting authentication services. Also, at step 406, the second identity provider attempts to get a cookie from the customer web browser. Since there is a cookie that contains a valid session identifier, the second identity provider determines that the customer is already logged in.

At step 408, the second identity provider determines whether there is an active session for the particular customer. Since the customer has a valid session on the second identity provider, the second identity provider does not need to ask the customer to supply their username and password. In a particular embodiment, the second identity provider determines which log server to user for session logging. Further, the second identity provider determines an opaque session identifier. In a particular embodiment, the opaque session identifier is used to uniquely identify a particular customer session from a pool of customer sessions for the time that this session is active on the second identity provider. The second identity provider determines the opaque session identifier from the per session information already maintained in the second identity provider web server.

Continuing to step 410, when a customer accesses the first service provider and the first service provider makes an authentication request to the second identity provider, a log record is sent from the second identity provider to a log server. In a particular embodiment, the log record includes the opaque session identifier, the second identity provider identifier, the first service provider identifier that is making the authentication request, a timestamp, and a record identifier that indicates that this is an “Authentication Request.” At step 412, the second identity provider sends an authentication response redirect message back to the customer web browser that includes an artifact. In a particular embodiment, the artifact provides the information that the first service provider needs in order to receive authentication information from the second identity provider. Also, in a particular embodiment, the artifact is encoded on the URL. Further, the redirect message redirects the browser to the first service provider.

At step 414, the customer web browser passes the authentication response that includes the artifact to the first service provider. Thereafter, at step 416, the first service provider makes a web services request to the second identity provider. In a particular embodiment, the web services request includes the artifact that the first service provider received from second identity provider through the customer web browser. At step 418, the second service provider validates the artifact in the web services request that is received from first service provider. Also, during step 418, the second identity provider creates an assertion to pass back to the first service provider in the response.

The Liberty ID-FF protocol provides a method to include additional information in the assertion. Since ID-FF uses security assertion markup language (SAML) to form assertions, the additional information can be included in the SAML assertion. From a Liberty ID-FF perspective the additional information can be included in the Liberty authentication context (<lib:AuthnContext>) portion of the protocol. In SAML, this information would be placed in the SAML advice (<saml:Advice>) portion of the SAML message. In a particular embodiment, the additional information can be in the form of tag value pairs. For example, there can be a tag value pair for the log server identifier, and the opaque session identifier. Including this information in identity provider (IDP) to service provider (SP) responses allows service providers to know which log server and which opaque session identifier to associate with the customer's session on the service provider.

Continuing to step 420, the second identity provider responds to the first service provider with the assertion response that includes the log server identifier and the opaque session identifier. The assertion response instructs the first service provider to either allow customer access or deny customer access to the first service provider. At step 422, the first service provider receives the assertion response from second identity provider and processes it. When the response allows access, it will include the log server identification and the opaque session identifier. The first service provider can take the log server identification and opaque session identifier and associate this information with the customer web session. Additional work may be required by the first service provider in order to fully create a customer session. In a particular embodiment, this work is performed below at step 426.

Proceeding to step 424, the first service provider sends a log message to the first log server that includes the opaque session identifier, the first service provider identifier, the second identity provider identifier, a timestamp, and a record identifier that indicates “Authentication Accepted” by the second identity provider. Moving to step 426, the first service provider creates the remaining data structures that are necessary to create a web session for the authentication customer web session. Next, at step 428, the first service provider transmits an initial page to the customer web browser. In a particular embodiment, the initial page can be a “landing page.” The “landing page” indicates to the customer that he or she has access to resources at the first service provider. In a particular embodiment, subsequent web activity or page refreshes occur between the first service provider and the customer web browser. In a particular embodiment, that activity may involve repeating one or more of the previous steps.

At step 430, the customer can follow a link at the first service provider or complete a form that gets posted to the first service provider. This activity can be considered a relevant event and each time a relevant event occurs relevant information logging can take place. At step 430, if a relevant event does not occur the method loops back to step 428. Otherwise, when a relevant event occurs, the method proceeds to step 432 and the first service provider sends a log message to the first log server. In a particular embodiment, the log record includes the opaque session identifier, the first service provider identifier, the second identity provider identifier, a timestamp, and a record identifier that indicates “Application Specific Information.” In a particular embodiment, the method returns to step 430 until the customer session with the first service provider ends.

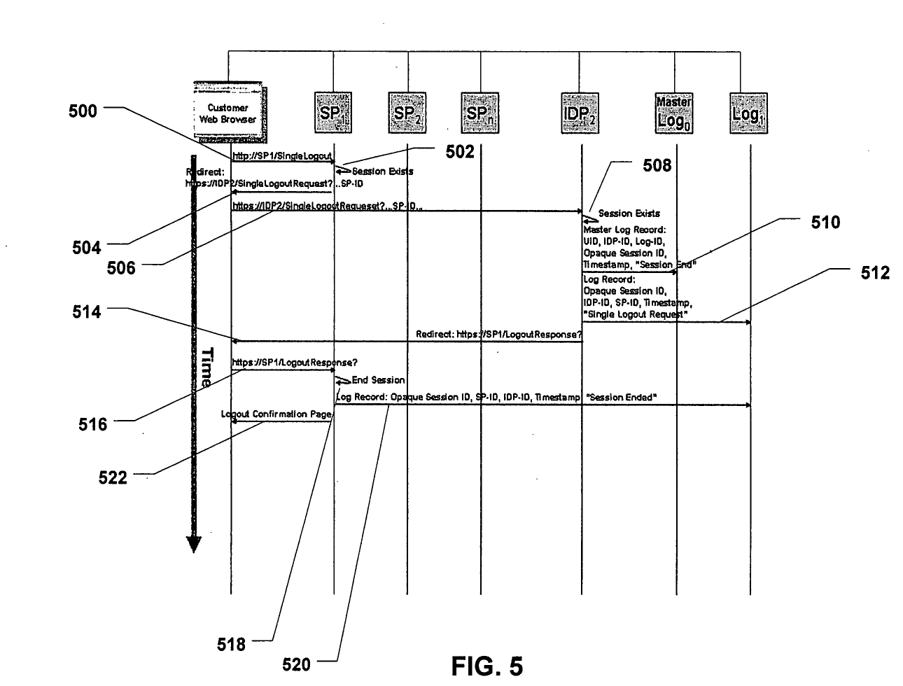

Referring to FIG. 5, a method of end-user session termination is presented as a ladder diagram. In general, there are two ways for end-user sessions to terminate. For example, the customer can purposefully log out of a web site by clicking on a logoff button. Otherwise, the session can time out through inactivity. However, in a single sign-on environment there can be two or more timeout points and two or more logoff points. For example, in the situation in which a customer is using single sign-on to access a number of applications, the timeout periods for each service provider and each identity provider may be different. Also, a customer can log out of a single service provider without logging out of the identity provider.

FIG. 5 illustrates the time sequence of events that occur when a customer performs a single log out. The intent of the customer would be to log out of all active service provider sessions and the identity provider in a single step. The method depicted in FIG. 5 operates under the assumption that the customer has a valid single sign-on session with one identity provider and one service provider.

Commencing at step 500, the customer toggles a single sign-off button or selects a single sign-off link that is provided by the first service provider and that is presented to the customer via the customer web browser. When either the button or link is selected, a logoff request can be passed to the service provider. The logoff request can be passed to the service provider encoded in a URL or through a form POST method. At step 502, the first service provider determines whether the customer has an existing valid session. If so, the method continues to step 504. At step 504, the first service provider sends the customer web browser a web redirect message in order to redirect the customer browser to the second identity provider. In a particular embodiment, the redirect URL contains encoded logoff request information. This information includes the first service provider identifier.

Proceeding to step 506, the single sign-off request is passed to the second identity provider through the URL encoded logoff request. Next at step 508, the second identity provider determines whether the customer has a valid session. Since the customer does indeed have a valid session, the method continues to step 510. At step 510, the second identity provider submits a log record to a master log server. The log record includes the Single Sign-On username, the second identity provider identifier, a log server identifier, an opaque session identifier, a timestamp, and a record type identifier indicating “Session End.” In a particular embodiment, the record type identifier indicates the end of the session in the master log server. Moving to step 512, the second identity provider submits another log record to a first logging server. In a particular embodiment, the log record includes the opaque session identifier, the second identity provider identifier, the first service provider identifier, a timestamp, and a record type identifier indicating the processing of a “Single Logoff Request.” After processing the logoff request, the second identity provider ends the active web session associated with the customer.

Continuing to step 514, the second identity provider sends a redirect message to the customer web browser to redirect the web browser back to first service provider. In a particular embodiment, the logoff response sent from second identity provider to the first service provider is encoded within the URL. At step 516, the customer web browser redirects to the first service provider. In a particular embodiment, the web browser delivers the encoded URL that contains the affirmative logoff response to the first service provider. Proceeding to step 518, the first service provider determines whether it has a valid session for the customer. Since it does, the first service provider processes the encoded URL and determines that it is an affirmative logoff response from the second identity provider.

At step 520, the service provider submits a log record to first log server. The log request contains the opaque session identifier, the first service provider, the second identity provider identifier, a timestamp, and a record type identifier indicating “Session Ended.” Then, the first service provider ends the customer session with the first service provider. Moving to step 522, the first service provider sends a logoff confirmation web page to the customer web browser.

In a particular embodiment, the above method covers the case in which a single service provider session is co-managed with an identity provider. When the customer accesses multiple service providers and has sessions on these service providers, the identity provider must notify each service provider that the session has ended. In a particular embodiment, this can be performed through a web service type message sent directly from the identity provider to each affected service provider. In this case, each service provider is responsible for making individual log entries indicating session end on the appropriate logging server.

The above description has focused primarily on the federated identity model as defined by the Liberty Alliance Identity Federation Framework (ID-FF) open standard approach to Single Sign-On. The following discussion applies the same concepts described above to the Web Trust model. The Web Trust model is the model supported directly by the proprietary IBM Tivoli Access Manager (TAM) product.

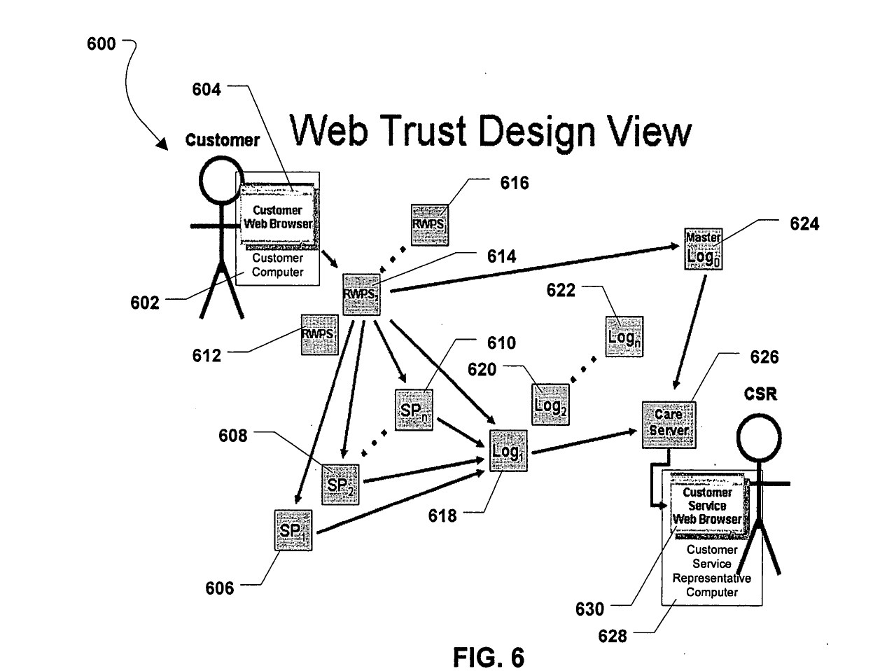

Referring to FIG. 6, a computer system that is suitable for use with the Web trust environment is shown and is generally designated 600. As shown, the system 600 includes a customer computer 602 that includes a customer web browser 604. The customer computer 602 can communicate with a first service provider 606, a second service provider 608, and an nth service provider 610. Access to the service providers 606, 608, 610 is made through a first reverse web proxy server 612, a second reverse web proxy server 614, and a jth reverse web proxy server 616. Each of the service providers 606, 608, 610 and each of the reverse web proxy servers 612, 614, 616 can communicate with a first log server 618, a second log server 620, and an nth log server 622. Each of the reverse web proxy servers 612, 614, 616 can also communicate with a master log server 624.

As illustrated in FIG. 6, the system 600 further includes a customer care server 626 that can communicate with the master log server 624 and the appropriate log server 618, 620, 622. A customer service representative computer 628 is coupled to the customer care server 626. The customer service representative computer 628 includes a customer service web browser 630 incorporated therein, e.g., stored within a computer readable medium.

In a particular embodiment, a customer can use the customer web browser 602 to access web sites provided by the service providers 606, 608, 610. All web site access is through the reverse web proxy servers 612, 614, 616. In a particular embodiment, the multiple reverse web proxy servers 612, 614, 616 can support different authentication domains. From the customer web browser point of view, the web interaction is only with the reverse web proxy servers 612, 614, 616. Each reverse web proxy server 612, 614, 616 can represent multiple domain names. Typically, the domain names can get mapped to the individual service providers 606, 608, 610 on the backend. In a particular embodiment, this centralized system can collect session information from each of the service elements and make consolidated session information available to a customer service representative via the customer service representative computer 628. Accordingly, the customer service representative's visibility into how the customer is using their services is greatly enhanced.

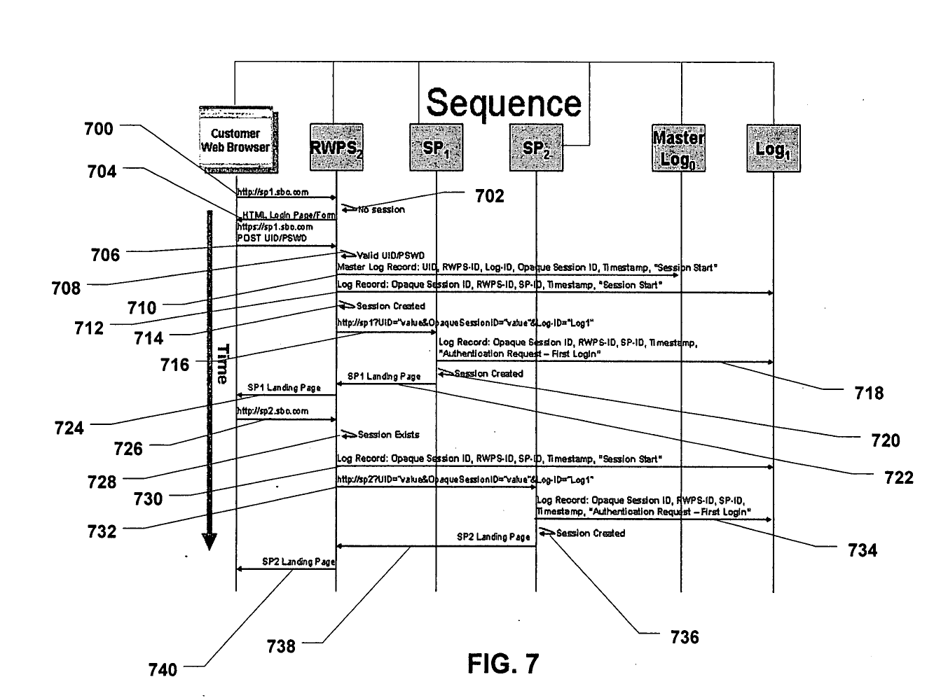

FIG. 7 shows a method of end-user session logging that is presented as a ladder diagram. In a particular embodiment, the method depicted in FIG. 7 is suitable for the Web Trust model described herein. The method illustrated in FIG. 7 operates under the assumption that a customer does not have an active Single Sign-On login session. Commencing at step 700, the customer directs the customer web browser to a reverse web proxy server, e.g., a second reverse web proxy server. At step 702, the second reverse web proxy server looks at the incoming HTTP request and determines that there is no current login session for this customer. Moving to step 704, the second reverse web proxy server sends a login page, e.g., a login form, to the customer web browser.

Next at step 706, the customer fills in the login form and submits it. In a particular embodiment, the form gets posted to the second reverse web proxy server. At step 708, the second reverse web proxy server validates the login information against either an internal or external database. Also, at step 708, the second reverse web proxy server determines which log server to use for session logging and also determines an opaque session identifier. In a particular embodiment, the log server choice is added to the session information maintained by the second reverse web proxy server. Further, in a particular embodiment, the opaque session identifier can be used to uniquely identify the customer session from a pool of customer sessions. The second reverse web proxy server adds the opaque session identifier to the per session information it normally maintains for login sessions. The internal session identifier of the second reverse web proxy server is not passed to a Service Provider (SP) or used as the opaque session identifier. If the internal session identifier is passed on, access to the log servers can allow hijacking of in-progress customer sessions.

Proceeding to step 710, the second reverse web proxy server sends a log record to the master log server. In a particular embodiment, the log record contains the customer single sign-on username, the second reverse web proxy server identifier, the first log server identifier, the opaque session identifier, a timestamp, and a record identifier that identifies this as a “SSO Session Start” record. Further, the log record information allows downstream systems, e.g., customer care support systems, to find the correct logging server for each customer single sign-on (SSO) session. At step 712, a log record indicating single sign-on session start is submitted to the log server. In a particular embodiment, this log record includes the opaque session identifier, the second reverse web proxy server identifier, the first service provider identifier, a timestamp, and a record identifier that shows that this is an “Authentication Request—First Login.”

Continuing to step 714, the second reverse web proxy server creates a login session for the customer. Thereafter, at step 716, the second reverse web proxy server forwards the request to the appropriate web server and encodes the customer username in the HTTP request. In addition to the encoded username in the HTTP request, additional information supporting logging in can be encoded as well. The encoded URL can be of the form:

http://sp1.sbc.com?UID=“value&OpaqueSessionID=”value”&Log-ID=“Log1”

The additional information includes the opaque session identifier and the log server identifier (Log-ID) for the first log server.

Proceeding to step 718, the first service provider decodes the encoded URL to get the username, the opaque session identifier, and the log server identifier. Further, the first service provider sends a log record to the first log server that includes the opaque session identifier, the first service provider identifier, the second reverse web proxy server identifier, a timestamp, and a record identifier indicating an “Authentication Request—First Login.” Next, at step 720, the first service provider receives the encoded HTTP request, determines that it is for a new session with an associated specific customer. Further, the portal creates a new session for this customer that includes the additional information supporting logging.

At step 722, the first service provider responds to the second reverse web proxy server with the landing page. Thereafter, at step 724, the second reverse web proxy server forwards the landing page response from the service provider to the customer web browser. Moving to step 726, the customer selects a link to a second service provider behind the second reverse web proxy server. The customer web browser sends the request to link to the second service provider, e.g., an HTTP request, to the second reverse web proxy server. Next, at step 728, the second reverse web proxy server receives the request to link to the second service provider. The second reverse web proxy server checks to see if the customer has a valid login session. Further, the second reverse web proxy server knows that this is the first time this customer has accessed the second service provider during the current login session.

Continuing to step 730, since this is the first time the customer has accessed the second service provider during the current login session, the second reverse web proxy server must make a log entry indicating a new service provider session start. The second reverse web proxy server sends a log record to the first log server that contains the opaque session identifier, the second reverse web proxy server identifier, the second service provider identifier, a timestamp, and a record identifier that indicates “Session Start.” At step 732, the second reverse web proxy server forwards the HTTP request on to the second service provider with the customer username encoded in the URL. Additional information that supports logging can also be encoded in the URL. This information can include the opaque session identifier and the first logging server identifier.

At step 734, the second service provider decodes the URL provided by the second reverse web proxy server. The second service provider sends a log record to the first log server that includes the opaque session identifier, the second reverse web proxy server identifier, the second service provider identifier, a timestamp, and a record identifier that indicate that this is an “Authentication Request—First Login.” Proceeding to step 736, a generic application at the second service provider decodes the URL and sees that the URL is for a new session and associates the passed username, the opaque session identifier, and the first log server identifier with the new login session. Next, at step 738, the second service provider responds to the HTTP request from the second reverse web proxy server with a landing page. Moving to step 740, the second reverse web proxy server forwards the second service provider landing page to the customer web browser.

With the configuration of structure described above, the system and method of tracking single sign-on sessions provides a way to determine which service providers and which identity providers a user encountered while browsing the Internet via a portal. Further, one or more of the systems and methods described herein provide a single logging infrastructure that scales to high transaction rates and to a large customer base. Additionally, one or more of the systems and methods described herein provides migration path to implementing single logging infrastructures across multiple identity and service providers. The one or more of the systems and methods described herein also provide better customer care and an ability to mine logs for customer behavior and use of all products.

In a particular embodiment, identity management security and privacy is assured. Further, in a particular embodiment, one or more of the systems and methods described herein can apply to multiple identity management models including the federated identity model and the web trust model. Also, in a particular embodiment, one or more of the systems and methods described herein can apply to hybrid identity management models that combine the federated identity model and the web trust model.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A service delivery system comprising:
a first service provider platform;
a second service provider platform;
an identity provider system to provide a single sign-on service with respect to the first service provider platform and the second service provider platform;
a log server to store session information created at the first service provider platform, the second service provider platform, and the identity provider system; and
a customer care application server to provide a customer care application, the customer care application server having access to the log server to retrieve the stored session information.

2. The service delivery system of claim 1, wherein the single sign-on service is compliant with a federated identity environment.

3. The service delivery system of claim 1, wherein the single sign-on service is compliant with a web trust identity environment.

4. The service delivery system of claim 1, further comprising a plurality of log servers and further comprising a master log server responsive to the identity provider system, the master log server including logic to identify, in response to a request from the customer care application server, one of the plurality of log servers having session information with respect to an end-user session identified by a single sign-on username.

5. The service delivery system of claim 1, wherein the stored session information is consolidated customer session information.

6. The service delivery system of claim 2, wherein the federated identity environment is a Liberty Alliance standard compliant environment.

7. The service delivery system of claim 1, wherein the customer care application server provides data to a customer server browser for use by a customer care service representative.

8. The service delivery system of claim 7, wherein the customer care service representative handles a call from a subscriber to a service offered in connection with the first service provider platform, the second service provider platform, or a combination thereof.

9. The service delivery system of claim 1, wherein the first service provider platform is an interactive web portal platform and the second service provider platform supports a communications services offering.

10. A system comprising:
a plurality of log servers to store session information created at a plurality of service provider platforms and a plurality of identity provider systems;
a master log server responsive to at least one of the plurality of identity provider systems, the master log server including logic to identify, in response to a customer care request, one of the plurality of log servers having session information corresponding to a particular end-user session identified by a single sign-on username;
a customer care application server to provide a customer care application to support a customer care representative, the customer care application server coupled to the master log server to provide the customer care request and having access to each of the plurality of log servers to retrieve consolidated multi-service session information related to the particular end-user session identified by the single sign-on username.

11. The service delivery system of claim 10, wherein the single sign-on service is compliant with a federated identity environment.

12. The system of claim 10, further comprising the plurality of service provider platforms and the plurality of identity provider systems, wherein each of the plurality of service provider platforms and the plurality of identity provider systems are interrelated and configured to provide a single sign-on service environment.

13. The system of claim 10, wherein at least one of the identity provider systems is a web server that validates end-users on behalf of at least one of the plurality of service provider platforms based on username and a password.

14. A method of creating a single sign-on session, comprising:
receiving a login request from a browser;
determining whether the browser has an active session;
transmitting a login form to the browser;
receiving a completed login form including a user identity information from the browser;
authenticating the user identity information;
identifying a log server to use for logging information related to a single sign-on session associated with the user identity information; and
determining an opaque session identifier associated with the single sign-on session.

15. The method of claim 14, wherein the opaque session identifier identifies a particular customer session from a pool of customer sessions.

16. The method of claim 14, wherein the log server is selected from a plurality of log servers via a round robin technique, via a least used technique, or randomly.

17. The method of claim 14, further comprising adding a log server identifier to a group of session information.

18. The method of claim 17, further comprising adding the opaque session identifier to the group of session information.

19. The method of claim 18, further comprising sending a first log record to a master log server.

20. The method of claim 19, wherein the first log record includes a single sign-on username, an identity provider identifier, the log server identifier, the opaque session identifier, a timestamp, and a record identifier that indicates a single sign-on session start.

21. The method of claim 19, further comprising sending a second log record to the log server.

22. The method of claim 21, wherein the second log record includes the opaque session identifier, the identity provider identifier, the service provider identifier associated with the login request, a timestamp, and a record identifier that indicates a first login authentication request.

23. The method of claim 21, further comprising sending an authentication response to the browser, wherein the authentication response includes a data item that can be used by a service provider to retrieve authentication information from the identity provider.

24. The method of claim 23, further comprising receiving a web services request from the service provider, wherein the web services request includes the data item.

25. The method of claim 24, further comprising validating the data item.

26. The method of claim 25, further comprising transmitting an assertion response to the service provider wherein the assertion response includes the log server identifier and the opaque session identifier.

27. A method of accessing a service provider when a prior single sign-on session is in place, the method comprising:
receiving a login request from a browser;
determining that the browser has an active session;
identifying a log server to use for logging of information related to the active session; and
determining an opaque session identifier.

28. The method of claim 27, wherein the opaque session identifier identifies a particular customer session from a pool of customer sessions.

29. The method of claim 28, further comprising adding a log server identifier and the opaque session identifier to the group of session information.

30. The method of claim 29, further comprising sending a log record to the log server, wherein the log record includes the opaque session identifier, the identity provider identifier, the service provider identifier associated with the login request, a timestamp, and a record identifier that indicates an authentication request.

31. The method of claim 30, further comprising sending an authentication response to the browser, wherein the authentication response includes an artifact that can be used by a service provider to retrieve authentication information from the identity provider.

32. The method of claim 31, further comprising receiving a web services request from the service provider, wherein the web services request includes the artifact.

33. The method of claim 32, further comprising transmitting an assertion response to the service provider wherein the assertion response includes the log server identifier and the opaque session identifier.

34. A method of single sign-off, comprising:
receiving a single sign-off request from a browser at a identity provider;
determining whether the browser has a valid session; and
submitting a first log record to a master log server, wherein the first log record includes a single sign-on username, an identity provider identifier, a log server identifier, an opaque session identifier, a timestamp, and a record type identifier that indicates a session termination.

35. The method of claim 34, further comprising submitting a second log record to a log server, wherein the second log includes the opaque session identifier, the identity provider identifier, the service provider identifier, a timestamp, and a record type identifier that indicates “Single Logoff Request.”

36. The method of claim 35, further comprising redirecting the browser back to the service provider.

37. A system comprising:
a plurality of log servers to store session information created at a plurality of service provider platforms and at a plurality of reverse web proxy servers;
a master log server responsive to at least one of the plurality of reverse web proxy servers, the master log server including logic to identify, in response to a customer care request, one of the plurality of log servers having session information corresponding to a particular end-user session identified by a single sign-on username;
a customer care application server to provide a customer care application to support a customer care representative, the customer care application server coupled to the master log server to provide the customer care request and having access to each of the plurality of log servers to retrieve consolidated session information related to the particular end-user session identified by the single sign-on username.

38. The system of claim 37, wherein each of the plurality of service provider platforms and the plurality of reverse web proxy servers are interrelated and configured to provide a single sign-on service environment.

39. The system of claim 38, wherein the single sign-on service environment is compliant with a web trust identity environment.

40. The system of claim 39, wherein the single sign-on service environment is further compliant with a federated identity environment.

41. A method of creating a single sign-on session, comprising:
receiving a request from a browser at a reverse web proxy server;
transmitting a login page to the browser;
receiving a completed login page from the browser, wherein the completed login page includes user login information;
determining whether the login information is valid; and
determining a log server to use for session logging after determining that the login information is valid.

42. The method of claim 41, further comprising determining an opaque session identifier, wherein the opaque session identifier identifies a particular customer session within a pool of customer sessions.

43. The method of claim 42, further comprising sending a first log record to a master log server, the first log record includes a customer single sign-on username, a reverse web proxy server identifier, a log server identifier, the opaque session identifier, a timestamp, and a record identifier that indicates a single sign-on session start.

44. The method of claim 43, further comprising sending a second log record to the log server, wherein the second log record includes the opaque session identifier, the reverse web proxy server identifier, the service provider identifier, a timestamp, and a record identifier that indicates a first login authentication request.

45. The method of claim 44, further comprising sending an encoded request to a service provider, the encoded request including the request from the browser, the opaque session identifier, and the log server identifier.

46. The method of claim 45, further comprising transmitting a landing page from a service provider to the browser.
